(19) United States
(12) Patent Application Publication
(10) Pub. No.: US 2007/0016345 A1
(43) Pub. Date: Jan. 18, 2007

(54) Synchronization of computer terminals in an aircraft

(76) Inventor: Oliver Plogmann, Wiesbaden (DE)

Correspondence Address: TRASK BRITT, P.O. BOX 2550, SALT LAKE CITY, UT, 84110, US

(21) Appl. No.: 11/484,013

(22) Filed: Jul. 10, 2006

Related U.S. Application Data
(60) Provisional application No. 60/698,715, filed on Jul. 13, 2005.

(30) Foreign Application Priority Data
Feb. 7, 2006 (EP) 06 002 445.2

(51) Int. Cl. G06F 17/00

(52) U.S. Cl. 701/3

(57) ABSTRACT

A method for providing information to a pilot computer terminal in a cockpit of an aircraft, wherein the method comprises selecting information by using the input means of a co-pilot computer terminal and synchronizing the selected information to the pilot computer terminal and a computer terminal for a cockpit of an aircraft for carrying out the acts of the method.

### CROSS-REFERENCE TO RELATED APPLICATION

This application claims the benefit of U.S. Provisional Application Ser. No. 60/698,715, filed Jul. 13, 2005, and further claims priority to European Patent Application No. 06 002 445.2, filed on Feb. 7, 2006, the disclosures of each of which are incorporated by reference herein in their entireties.

### BACKGROUND OF THE INVENTION

1. Field of the Invention

The present invention relates to computer terminals for cockpits of aircrafts, in particular, to use of the computer terminals during flight.

2. State of the Art

In more and more cockpits of aircrafts, computer terminals are used to present certain information to the pilots. Examples for such information are flight charts. The computer terminal is connected to a keyboard, a track ball, a mouse and/or comprises a touch screen or line selecting keys to request the computer terminal to generate the appropriate flight chart for the present flight situation and to display the chart on a screen.

However, during the flight, the pilot may not be able to request and to select the appropriate information, since he must concentrate on the flight.

Therefore, it would be advantageous to provide a system and a method for selecting and generating information for a computer terminal of the pilot in an aircraft cockpit without the need of the attention of the pilot.

Additional features and advantages of the present invention will become apparent upon reading of the specification with reference to the drawings.

### BRIEF SUMMARY OF THE INVENTION

According to one aspect of the present invention, a method for providing information to a pilot computer terminal is provided. The method comprises: selecting information by using the input means of a co-pilot computer terminal and synchronizing the selected information to the pilot computer terminal.

As used herein, the terms “pilot computer terminal” and “co-pilot computer terminal” refer to two different computer terminals in a cockpit and do not relate to the rank of the present user. However, in for purposes of convenience in describing various aspects of the present invention, the pilot computer terminal is the computer terminal which receives information from the co-pilot computer terminal, whereas the co-pilot computer terminal is the computer terminal which sends the information to the pilot computer terminal. Therefore, the co-pilot computer terminal may also be called “master,” whereas the pilot computer terminal may also be called “slave.” Since both computer terminals may comprise the same functionality, each of the computer terminals may act at one point in time as pilot computer terminal and at another point in time as co-pilot computer terminal.

For simplicity, the several embodiments described are based on the communication between two computer terminals. However, as a matter of course, the co-pilot computer terminal may also synchronize information with more than one pilot computer terminal.

According to one embodiment of the invention, the information for the pilot computer terminal is selected based on inputs via the input means of the co-pilot computer terminal. Examples for such input means include a keyboard, a mouse, a track ball, a touch screen or line select keys. In addition, every other technology may be used which enables a user to inform the computer terminal about his needs.

The information to be selected by the co-pilot via the input means includes, for example, a flight chart. In one particular embodiment of the present invention, the selected information, for example the selected flight chart, will be generated based on data stored in a database. The generated information may be displayed on a display of the co-pilot computer terminal. The co-pilot may check whether the generated and displayed chart is correct.

According to one aspect of the present invention, in response to input at the pilot computer terminal or at the co-pilot computer terminal, the selected information at the co-pilot computer terminal is synchronized with the pilot computer terminal. Of course, the co-pilot may synchronize information relating to one or more charts with the pilot computer terminal.

Each of the computer terminals may comprise a database with certain data based on which flight charts may be generated. However, according to another embodiment, the pilot computer terminal and the co-pilot computer terminal may be connected to the same database.

In one particular embodiment of the method according to the present invention, the method further comprises affecting the information displayed on the co-pilot computer terminal via the input means of the co-pilot computer terminal. Examples for affecting the information include: to zoom in or out, to pivot the pane, to change between day mode and night mode, to show or hide certain subcharts and to change from normal view to full screen mode and vice versa. In one embodiment, these settings made by the co-pilot are also synchronized between the co-pilot computer terminal and the pilot computer terminal.

In a further embodiment, the synchronization comprises sending information relating to the charts and the selected settings from the co-pilot computer terminal to the pilot computer terminal. This information may comprise a clear indication of which chart was selected by the co-pilot and which settings were chosen by the co-pilot. Based on this information, the pilot computer terminal generates the same charts with the same settings as selected on the co-pilot computer terminal. Additionally, the generated information with the same settings may be displayed on a display of the pilot computer terminal.

In one embodiment, the information sent from the co-pilot computer terminal to the pilot computer terminal comprises a reference to the version of the chart selected at the co-pilot computer terminal. If the pilot computer terminal has only access to an older version of this chart, the pilot computer terminal may request as part of the synchronization via the co-pilot computer terminal a copy of the data relating to this chart or of the data relating to the differences between the older and the newer version. Corresponding acts may be carried out if the pilot computer terminal may have access to a newer version of the chart than the co-pilot computer terminal. In this case, the pilot computer terminal provides the co-pilot computer terminal with corresponding data.

In another embodiment, various security functions may also be provided. For example, one function may ensure that inputs via the input means of the pilot computer terminal overrule changes synchronized by the co-pilot computer terminal.

In accordance with another aspect of the present invention, a computer terminal for a cockpit of an aircraft is provided, wherein the computer terminal comprises a network connection which can be used to connect the computer terminal to at least one further computer terminal. The computer terminal comprises means for receiving information from the at least one further computer terminal and for sending information to the at least one further computer terminal. Further, the computer terminal is configured to select information via input means of the computer terminal and to synchronize the selected information with the at least one further computer terminal via the network connection.

The computer terminal may comprise a processor, a memory, output means and input means. According to one particular embodiment, input means and output means may include a touch screen or a screen with line select keys. The computer terminals may also comprise further connections, such as connections to other systems within the cockpit.

In one particular embodiment of the present invention, the computer terminal is connected to a database. Further, the computer terminal may comprise means for generating the selected information based on data stored in the database. The computer terminal may also comprise means for displaying the generated information on a display of the co-pilot computer terminal.

In another embodiment, the computer terminal according to the present invention may be configured to affect the information displayed on the computer terminal via the input means. Examples for affecting the information include: to zoom in or out, to pivot the pane, to change between day mode and night mode, to show or hide certain subcharts and to change from normal view to full screen mode and vice versa.

In accordance with yet another embodiment, the configuration of the computer terminal to synchronize the selected information includes sending information relating to the selected information and, in a further embodiment, information relating to the selected settings from the co-pilot computer terminal to the pilot computer terminal.

Therefore, the method, the system and the computer terminal according to the present invention enable information to be displayed on the computer terminal of a pilot without the interaction of the pilot.

Further embodiments are also set forth herein.

### BRIEF DESCRIPTION OF THE DRAWINGS

The foregoing and other advantages of the invention will become apparent upon reading the following detailed description and upon reference to the drawings in which:

FIG. 1 is a schematic diagram of a computer system comprising a pilot computer terminal and a co-pilot computer terminal;

FIG. 2 is a flow chart illustrating the process of setup synchronization; and

FIG. 3 is flow chart showing the process of synchronizing a specific chart.

### DETAILED DESCRIPTION OF THE INVENTION

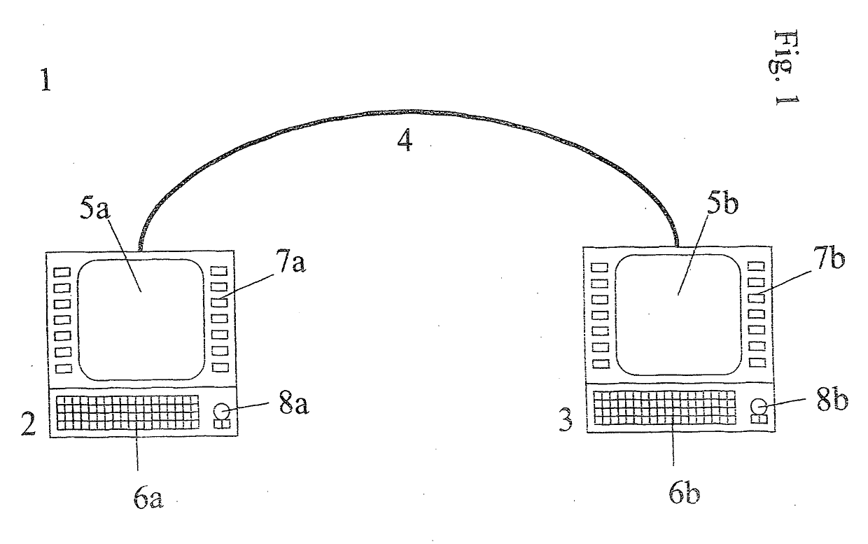

FIG. 1 shows a computer system 1 which may be used in connection with the present invention. In the example shown in FIG. 1, the computer system 1 comprises two computer terminals 2, 3, a co-pilot computer terminal 2 and a pilot computer terminal 3. The two computer terminals 2, 3 are connected, for example, via a network connection 4. In this network, the two computer terminals are identified by an individual IP number and/or an individual name and the communication between the computer terminals may be established, for example, using the TCP/IP protocol (transmission control protocol/internet protocol) as will be appreciated by those of ordinary skill in the art.

Both computer terminals 2, 3 comprise means for receiving information from the other computer terminal and for sending information to the other computer terminal, wherein the computer terminals are configured to select information, in particular flight charts, and to synchronize the information with the other computer terminal via the network connection 4.

In order to carry out these tasks, each computer terminal 2, 3 may include a processor, a memory, output means and input means. In the computer terminals 2, 3 shown in FIG. 1, output means may include a screen 5 (also called display) and input means may include a keyboard 6, line select keys 7 and a track ball 8. Further, the computer terminals 2, 3 comprise a network connection 4 via which the computer terminals are connected with each other. The computer terminals 2, 3 may also comprise further connections, such as connections to other systems within the cockpit and to a database.

As a part of the preparation for the flight, the pilot/co-pilot sets up the computer terminal 2, 3, this includes selecting all charts which are relevant for the flight. These charts include, for example, charts about the departure airport and the arrival airport with a very detailed scale, charts about the surrounding areas of these airports with a less detailed scale and charts about the overflight areas with a relative large scale. The software in the computer terminals enables arranging the selected charts in different windows to form a so-called clipboard in order to enable the pilot to easily switch between these charts. Further, the pilot and/or the co-pilot may affect the charts by selecting certain settings individually for each of the charts which may be favorable for the planned flight.

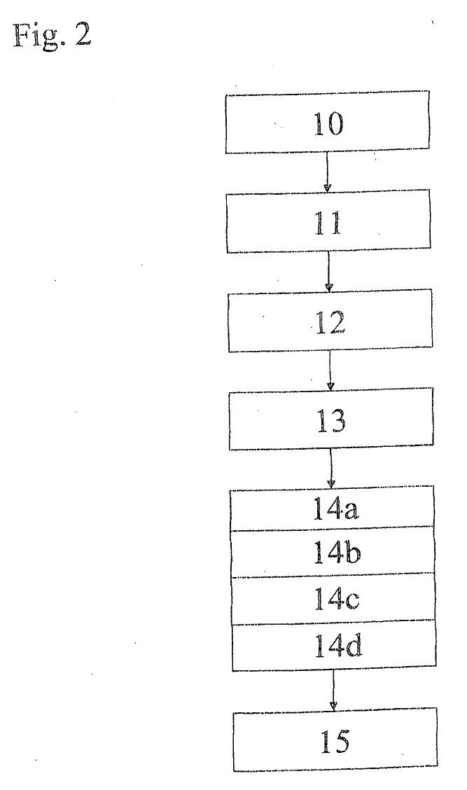

The method according to one aspect of the present invention enables synchronizing the above-described setup from one computer terminal to the other computer terminal. The process of synchronization of the result of the setup at one computer terminal according to the present invention is described with reference to the flow chart in FIG. 2.

In a first act 10, the co-pilot selects the charts to be generated. The charts may be distinguished based on the covered area and based on level of information. For example, the pilot may select a different chart for an area surrounding an airport, depending on whether he wants to land at this airport or whether he wants to fly over this area. In a further act 11, the selected charts will be generated based on data stored in a database. All generated charts will be displayed on the screen (act 12) such that the pilot may easily choose the chart he wants.

In act 13, the pilot has the possibility of choosing individual settings for each of the charts thereby affecting the representation of the charts. Examples for settings are the zoom-level, center position, changing between day mode and night mode, showing or hiding certain subcharts and changing from normal view to full screen mode and vice versa.

In order to enable the pilot to use the same charts as already selected by the co-pilot, in act 14 the co-pilot computer terminal and the pilot computer terminal are synchronized. This synchronization may further comprise the following acts: first 14a, information identifying the selected and generated charts is collected; second 14b, information with respect to the selected settings for each chart is collected; third 14c, the collected information is sent from the co-pilot computer terminal to the pilot computer terminal; and fourth 14d, in the pilot computer terminal the charts are generated based on the transmitted information.

In a further act 15, the charts with the selected settings are displayed at the pilot computer terminal.

Depending on the requests of the pilot and/or the co-pilot, information relating to all charts or only to certain charts is collected and transmitted. The pilot and/or the co-pilot may also select whether all settings or only certain settings are collected and transmitted. This may be realized by a function which asks the co-pilot which charts and which settings should be transmitted to the pilot computer terminal. Further, the pilot computer terminal may also ask the pilot which charts and which settings should be received from the co-pilot computer terminal. This functionality enables that only such information is exchanged between the two computer terminals which is helpful for the receiving computer terminal.

According to one embodiment of the present invention, the method for synchronizing the setup information from one computer terminal to another includes an act of verification in which the pilot computer terminal, i.e. the receiving computer terminal, verifies that he has access to the data relating to the version of the chart to be generated.

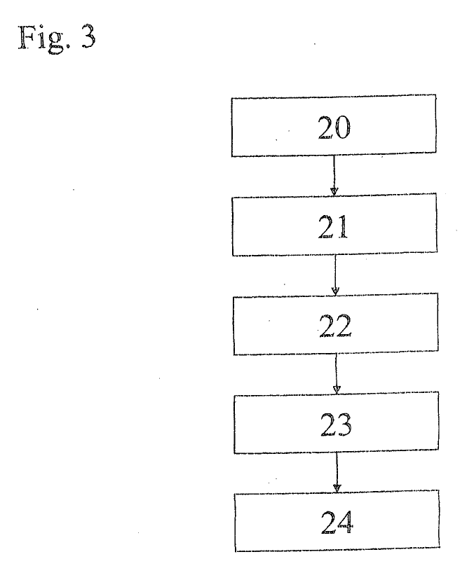

In another embodiment of the present invention, only one chart and its settings is synchronized between the co-pilot computer terminal and the pilot computer terminal. FIG. 3 illustrates this embodiment of the present invention. This function may be used if, during the flight, one chart becomes important which was not selected during the initial setup procedure or if the co-pilot wants to support the pilot by updating the settings of an already selected chart. This enables the pilot to further concentrate on the flight, whereas the co-pilot selects and/or affects the chart on the co-pilot computer terminal.

In a first act 20, the co-pilot selects the information to be synchronized. This may be a chart which was already generated or a complete new chart. In the present example, the selected chart was not generated and therefore, in act 21, the chart is generated and displayed (act 22) on the co-pilot computer terminal. In a next act 23, the co-pilot specifies settings, such as the present position, a zoom setting and which details should be displayed on the chart. In response to input at the pilot-computer terminal or at the co-pilot computer terminal, the chart and the corresponding settings are synchronized with the pilot computer terminal (act 24). This synchronization includes sending information relating to the respective chart and the selected settings.

In another embodiment of the invention, an ongoing synchronization between the pilot computer terminal and the co-pilot computer terminal may be established. Such an ongoing synchronization may be desirable, if the pilot concentrates on the flight, whereas the co-pilot may support the pilot by selecting the desired charts from the clipboard and changing the current settings according to the needs of the pilot. For example, the co-pilot may assist the pilot by changing the zoom-level. Further, the co-pilot may select for the pilot, another chart from the clipboard. These supporting actions of the co-pilot are enabled by the inventive synchronization function of the present invention.

This embodiment may be realized by repeatedly carrying out the method described in connection with FIG. 3, wherein the act of synchronization may be initiated automatically or in response to input by the co-pilot.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A method for providing information to a pilot computer terminal in a cockpit of an aircraft, wherein the method comprises:
selecting information by using the input means of a co-pilot computer terminal; and
synchronizing the selected information to the pilot computer terminal.

2. Method according to claim 1, wherein the method further comprises:
generating the selected information based on data stored on a database; and
displaying the generated information on a display of the co-pilot computer terminal.

3. Method according to claim 2, wherein the method further comprises:
affecting the information displayed on the co-pilot computer terminal via the input means of the co-pilot computer terminal.

4. Method according to claim 3, wherein affecting the displayed information includes to zoom in or out, to pivot the pane, to change between day mode and night mode, to show or to hide certain subcharts and/or to change from normal view to full screen mode and vice versa.

5. Method according to claim 4, wherein synchronizing the selected information to the pilot computer terminal further includes:
sending information relating the selected charts from the co-pilot computer terminal to the pilot computer terminal; and
generating the selected charts at the pilot computer terminal.

6. Method according to claim 4, wherein synchronizing the selected information to the pilot computer terminal further includes:
sending information relating to selected charts together with the selected settings for each chart from the co-pilot computer terminal to the pilot computer terminal; and
generating the selected charts with the selected settings at the pilot computer terminal.

7. Method according to claim 6, wherein the method further comprises:
displaying the generated charts with the selected settings on a display of the pilot computer terminal.

8. Method according to claim 1, wherein synchronizing the selected information to the pilot computer terminal further includes:
sending information relating to selected charts from the co-pilot computer terminal to the pilot computer terminal; and
generating the selected charts at the pilot computer terminal.

9. Method according to claim 8, wherein the method further comprises:
displaying the generated charts on a display of the pilot computer terminal.

10. Method according to claim 1, wherein synchronizing the selected information to the pilot computer terminal further includes:
sending information relating to selected charts together with the selected settings for each chart from the co-pilot computer terminal to the pilot computer terminal; and
generating the selected charts with the selected settings at the pilot computer terminal.

11. A computer terminal for a cockpit of an aircraft, comprising:
means for receiving information from the at least one further computer terminal and for sending information to the at least one further computer terminal;
wherein the computer terminal is configured to select information via input means of the computer terminal and to synchronize the selected information with the at least one further computer terminal via the network connection; and
wherein the computer terminal is connected via a network connection to at least one further computer terminal.

12. The computer terminal according to claim 11, wherein the computer terminal comprises at least a processor, a memory, output means and input means.

13. The computer terminal according to claim 12, wherein the input means and output means include at least one of a touch screen and a screen with line select keys.

14. The computer terminal according to claim 11, wherein the computer terminal also comprises a connection to another system within the cockpit.

15. The computer terminal according to claim 14, wherein the computer terminal is configured to send information relating to the selected information and to selected settings to the at least one further computer terminal via the network connection.

16. The computer terminal according to claim 11, wherein the computer terminal is connected to a database.

17. The computer terminal according to claim 11, wherein the computer terminal is configured to affect the information displayed on the computer terminal via the input means.

18. The computer terminal according to claim 11, wherein the computer terminal is configured to send information relating to the selected information and to selected settings to the at least one further computer terminal via the network connection.

19. A computer system comprising:
at least two computer terminals connected via a network connection, at least one of the two computer terminals comprising:
means for receiving information from the other computer terminal and for sending information to the other computer terminal;
wherein the at least one computer terminal is configured to select information via input means of the at least one computer terminal and to synchronize the selected information with the other computer terminal via the network connection.

20. The computer system of claim 19, wherein the at least one computer terminal is configured to send information relating to the selected information and to selected settings to the at least one further computer terminal via the network connection
